(19) United States
(12) Patent Application Publication
(10) Pub. No.: US 2008/0089351 A1
(43) Pub. Date: Apr. 17, 2008

(54) Flow control in communication networks

(76) Inventor: Chunfeng Hu, Singapore (SG)

Correspondence Address: BRINKS HOFER GILSON & LIONE;INFINEON, PO BOX 10395, CHICAGO, IL, 60610, US

(21) Appl. No.: 11/580,509

(22) Filed: Oct. 13, 2006

(51) Int. Cl. H04L 12/56

(52) U.S. Cl. 370/412; 370/235

(57) ABSTRACT

A communications queue controller for a communications network, the queue controller having a plurality of queue buffers of differing priorities. Each queue buffer has a flow control selector controllable by a programmable bit.

### BACKGROUND

1. Field of the Invention

This invention relates to flow control in communications networks.

2. Description of Related Art

In communications networks, such as Ethernet networks, flow control is a mechanism to manage the data flow between two working devices. In Ethernet networks, the two devices will be Ethernet devices. The IEEE standard IEEE 802.3X proposes to use a pause control Media Access Control (MAC) frame for completely shutting down a link if that link becomes congested. Although the congested link is no longer an issue after shutdown, all data transmission over the link is prevented an undesirable result. Additionally, this solution is Ethernet-port based and cannot solve certain problems in networks that require queue-specific flow control.

### BRIEF DESCRIPTION OF THE DRAWINGS

FIG. 1 is an illustration of an exemplary embodiment of flow control in a communications network;

FIG. 2 is an illustration of another exemplary embodiment of flow control in a communications network;

FIG. 3 is an illustration of frame formats for use with the embodiment of FIG. 2; and

FIG. 4 is an illustration of an alternative frame format for use with the embodiment of FIG. 2.

### DETAILED DESCRIPTION

In order that the invention may be fully understood and readily put into practical effect there shall now be described by way of non-limitative example only exemplary embodiments of the present invention, the description being with reference to the accompanying illustrative drawings.

Throughout the description like components have like reference numerals with the addition of a prefix number indicating the drawing figure number.

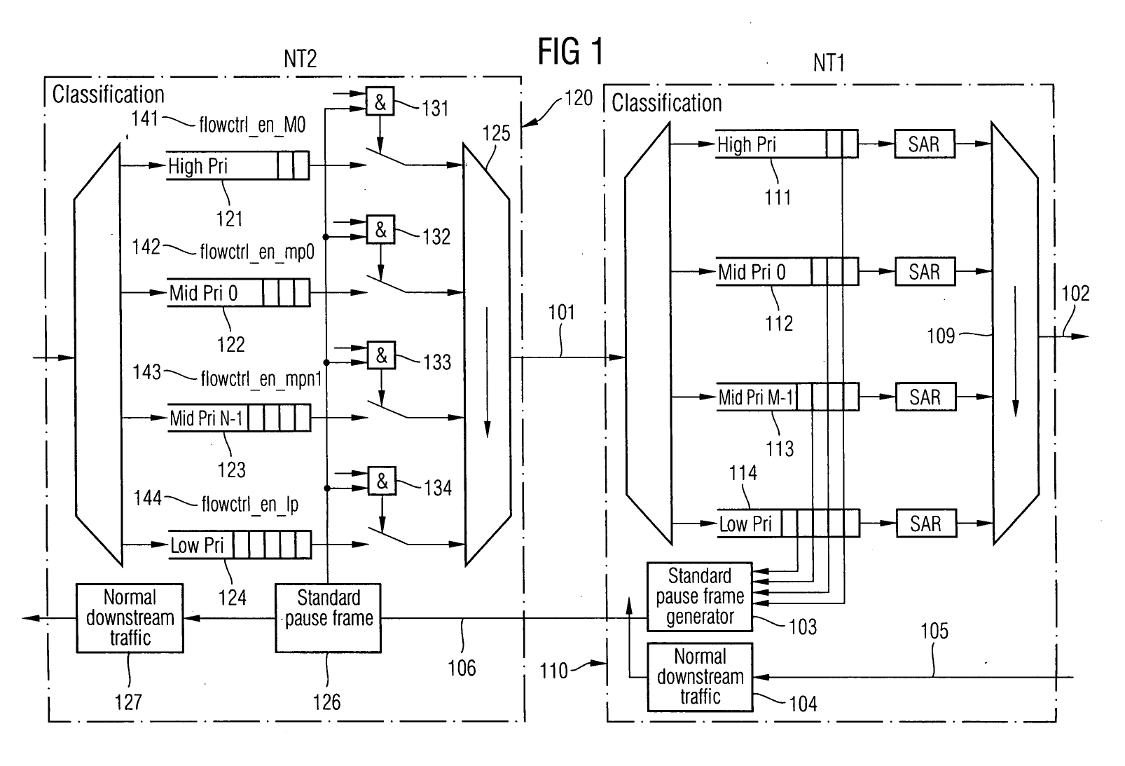

Referring to FIG. 1, a part of a communications system such as an Ethernet system is shown. In the illustrated part of the communications system, a queue-based flow control system is utilized. In the exemplary illustration of FIG. 1, the part of the communications system includes a network termination type 1 (NT1) and a network termination type 2 (NT2).

Network Termination type 1 (NT1) represents a layer 1 device that hides the physical characteristics of the WAN (wide area network) interface for a network such as a home, office, educational institution or business network. Network Termination type 2 (NT2) contains access control functions between the network and a public network. A fast Ethernet link 101 may be used to interface between NT1 and NT2. For example, the fast Ethernet link 101 may be of the order of 100 Mb/s.

The rate of the upstream access line 102 for NT1 is usually less than the transmission rate of the fast Ethernet link 101. Given the example above, if the link is 100 Mb/s then the rate for upstream 102 will be less than 100 Mb/s. Therefore, both NT1 and NT2 have priority queues generally designated as 110 and 120 respectively. The number of priority queues in 110 and 120 may be any suitable or required number. The number of queues 110, 120 in NT1 and NT2, respectively, may be the same or different. However, both NT1 and NT2 may have, for example, at least two priority queues. As shown, both NT1 and NT2 have four queues 111, 112, 113 and 114 for NT1; and 121, 122, 123 and 124 for NT2.

The scheduling in the scheduler 125 of NT2 according to embodiments of the present invention is at the packet level. To assure the low latency of high priority traffic over the low physical rate of NT1, scheduling in the scheduler 109 of NT1 is segment based. As such, the flow control system between NT1 and NT2 preferably gives the maximum use of the rate of the upstream access line 102 and the lowest possible latency for high priority traffic. For example, it is preferably less than the segment size/access line rate; and no buffer overflow in NT1.

The four queue buffers 111 to 114 of NT1 are preferably of different priorities: high priority 111, mid-priority queue 0 112, mid-priority M-1 113, and low priority 114. The four queue buffers 121 to 114 of NT2 are preferably of different priorities: high priority 121, mid-priority queue 0 122, mid-priority M-1 123, and low priority 124. Priority of received data frames may be determined by the type or category of data—voice, video, and so forth.

Whenever any one or more of the queue buffers 111 to 114 are full, a standard pause frame is generated at pause frame generator 103. The standard pause frame generated at generator 103 is added to the normal downstream traffic 104 of the downstream access line 105 and sent to NT1 over the downstream Ethernet link 106. At NT2, an extractor 126 extracts the standard pause frame from the normal downstream traffic 127.

In NT2, the flow control on/off (enable/disable) selectors 131, 132, 133 and 144 for the queue buffers 121 to 124 respectively is static and programmable by use of a programmable control bit 141, 142, 143 and 144 respectively contained in the queue scheduling block. There is one programmable bit 141 to 144 for each priority stream/queue buffer 121 to 124.

Upon receipt and extraction of the standard pause frame, the low priority queue(s) 124 are shut down. High priority queue(s) 121 continue to send data over the upstream link 101. The programmable bit 141 will normally be set such that data transmission can continue as long as the rate of the high priority traffic 121 is less than the upstream access line 102 rate. As this is known at installation, the programmable bit 141 can be set ON to enable transmission. The programmable bit 144 of the low priority queue 124 is set such that when the standard stop frame is received, it immediately stops sending data. It will remain stopped until another standard pause frame is received allowing it to start sending data. The programmable bits 142 and 143 of the mid-priority queues 122 and 123 will be set according to the specifications of the system, particularly the respective line rates. In general, however, the lower the priority, the more likely the queue is to be shut down upon a standard pause fame being received.

If the control bit 141 to 144 is set to ON, and the standard pause frame is received, the respective queue ignores the pause frame. As it is enabled it will continue to send data. If the control bit 141 to 144 is set to OFF, the respective queue will respond to the pause frame and stop sending data. When a standard pause frame is received, the respective queue is disabled and will be shut down, data no longer being sent by that queue. The shut down will remain until a further pause fame is received enabling the sending of data. Usually the peak and/or sustained rate of the high priority and latency sensitive stream 121 is less than the rate of the upstream access line 102, so high priority queues (e.g. 121) that are not shut down by the standard pause frames won't cause buffer 111 to overflow in NT1 devices.

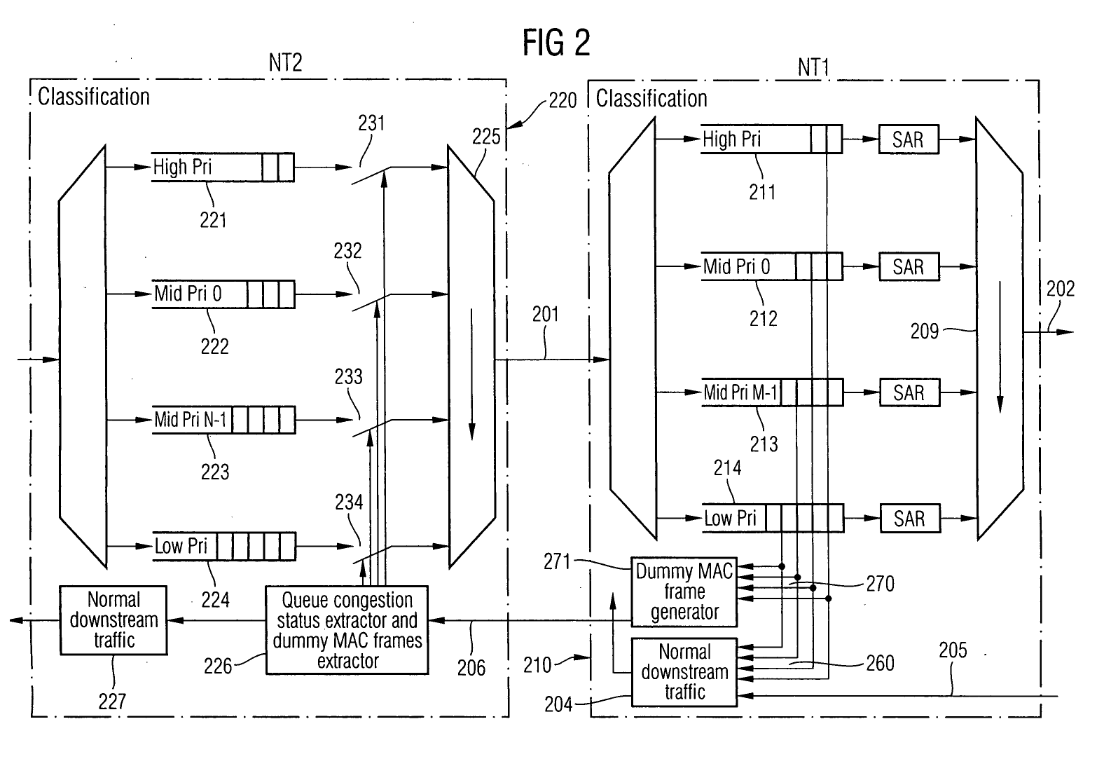

Another exemplary embodiment is illustrated in FIGS. 2 to 4 where like components use like reference numerals but with the prefix number changed to reflect the number of the drawing figure. This exemplary embodiment does not use pause control frames. Flow control information is carried over the downstream Ethernet link 206 as before, but in this case the queue congestion status data is inserted into data frames or dummy data frames sent from NT1 to NT2. The information is only one or several bytes. But as the queue congestion status data is smaller, and is sent in data frames or dummy data frames, the effect on bandwidth is reduced when the congestion status changes frequently.

The queue congestion status data is handled in one or both of two ways: (a) using an appender 204 to append the congestion status information 260 to the end of every data frame; and (b) using a dummy frame generator 272 to generate and transmit a dummy data frame that includes the queue congestion status data 272.

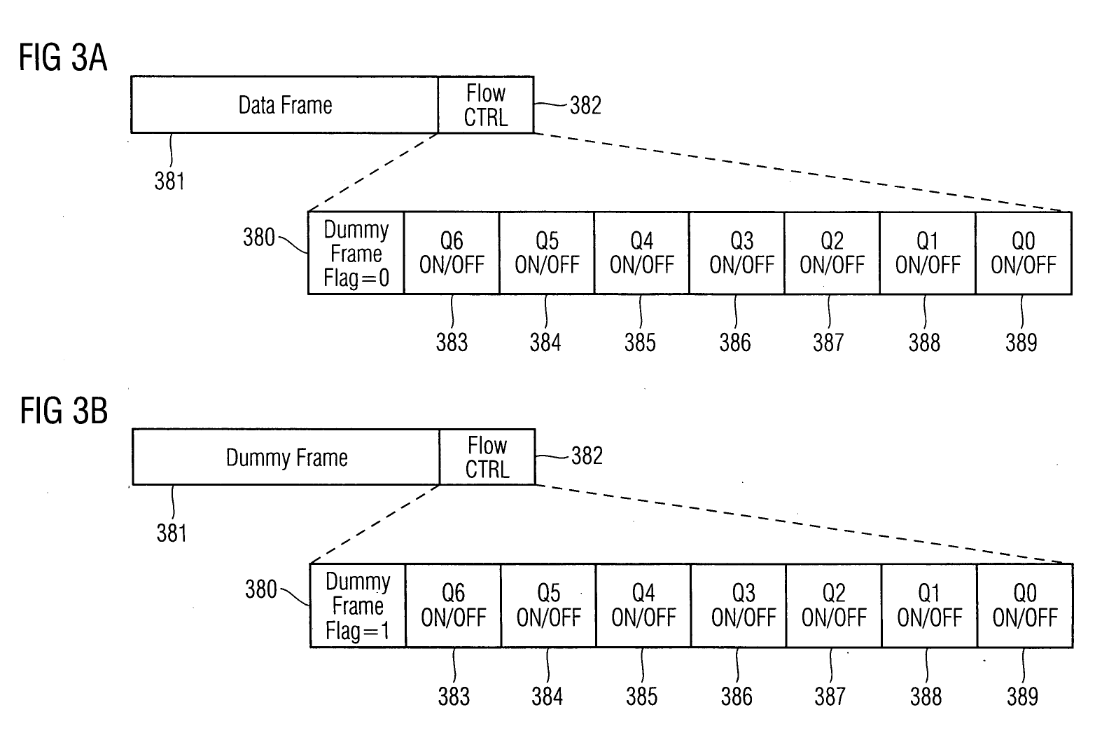

For (a)—appending the queue congestion status data to the end of every data frame—the queue congestion status data 382 (1 byte) is appended to the end of frame 381. As shown in FIG. 3, one bit 380 in the queue congestion status data 382 is used to indicate if the frame is a valid data frame (FIG. 3(a)) or a dummy data frame (FIG. 3(b)). In addition, there is one bit per queue (383 to 389 for queues 6 to 0 respectively) flagging to NT2 to close or open the upstream data traffic from the associated one of queues 221, 222, 223 and 224. If there are seven or fewer queues (as illustrated) only one byte is appended to the end of every downstream frame 382. If there are more than seven queues, extra bytes are added to the end of the downstream data frames, as required.

If the upstream congestion status changes and there is no downstream traffic, a dummy data frame (FIG. 3(b)) is generated by dummy data frame generator 272 and transmitted to NT2. The dummy data frame also includes the queue congestion status data. This is case (b) above.

In both cases, the flow control byte 382 is extracted by extractor 226, parsed, and NT2 acts accordingly by switching on or off the traffic in each of the upstream queues 221, 222, 223 and 224. In the case of the dummy data frame 381, the frame is also extracted by extractor 226.

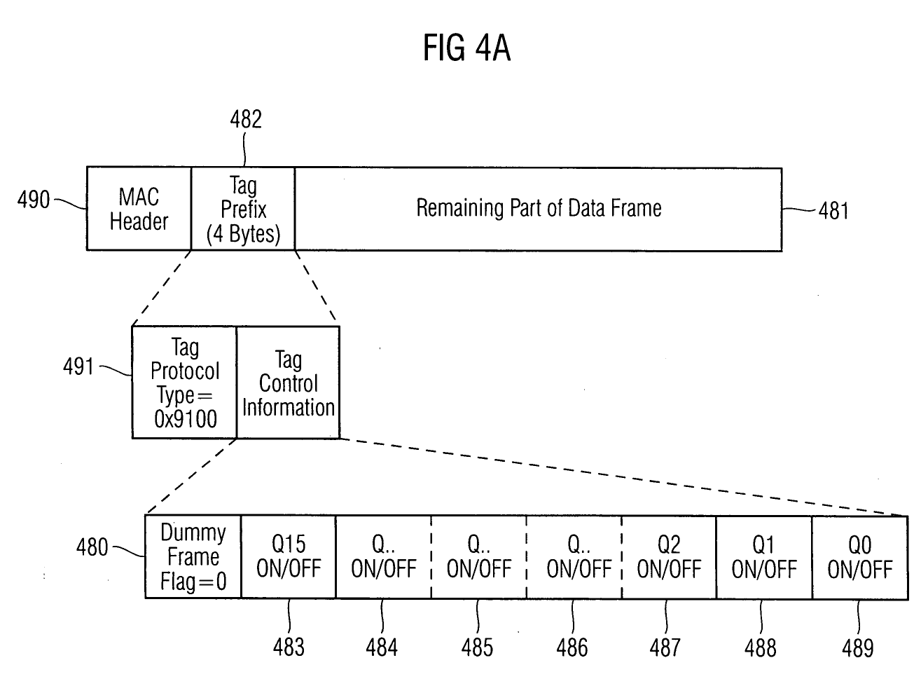

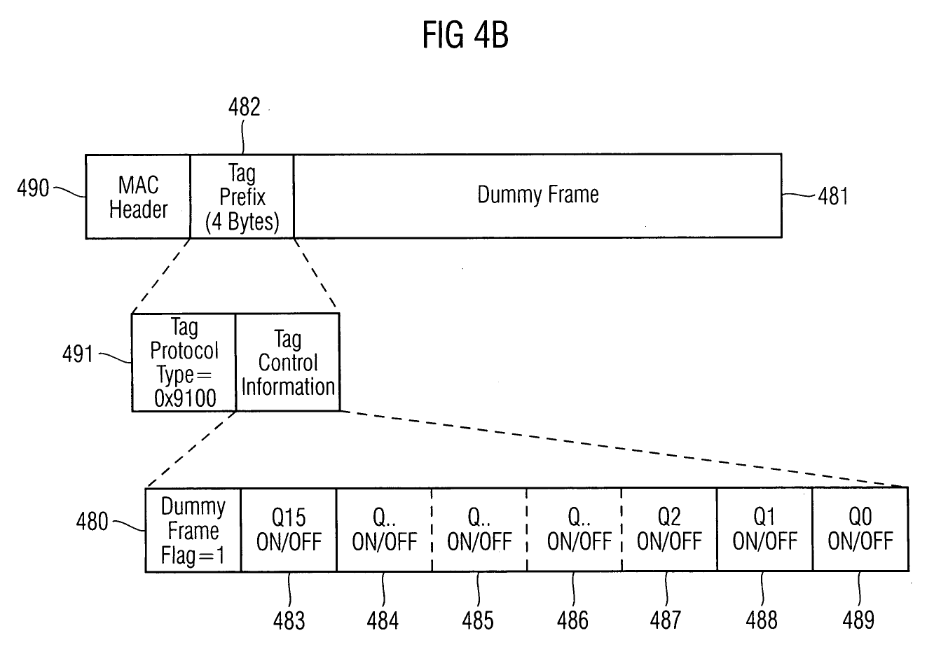

Alternatively, and as shown in FIG. 4, the queue congestion status data may be inserted into a data frame, or a dummy data frame is generated, and transmitted to NT2 only when the queue congestion status data changes. To do this, a 4-byte tag field 482 is inserted in the downstream data frames 481 (FIG. 4(a)) or a dummy data frame (FIG. 4(b)). The tag field 482 is preferably immediately following the MAC header 490. The dummy data frame is again generated when there is no downstream traffic. As not all frames carry a special tag field, the tag type field 491 has a unique value so that the NT2 device can recognise and extract the queue congestion status data.

In an exemplary form, a software arrangement is provided on each of NT1 and NT2 that is operable on at least one processor in each of NT1 and NT2. The software arrangement comprises a computer program that configures the at least one processor to control the data flow from NT2 to NT1.

Whilst there has been described in the foregoing description exemplary embodiments of the present invention, it will be understood by those skilled in the technology concerned that many variations in details of design, construction and/or operation may be made without departing from the present invention.

I/We claim:

1. A communications queue controller for a communications network, the queue controller comprising a plurality of queue buffers of differing priorities, each queue buffer comprising a flow control selector controllable by a programmable bit.

2. The telecommunication queue controller as claimed in claim 1, wherein the programmable bit is provided in a queue scheduling block of each of the plurality of queue buffers.

3. The communications queue controller as claimed in claim 1, wherein when the programmable bit is on, the flow control selector is enabled and does not respond to received pause instructions.

4. The communications queue controller as claimed in claim 1, wherein when the programmable bit is off, the flow control selector responds to received pause instructions.

5. The communications queue controller as claimed in claim 3, wherein when the programmable bit is off, the flow control selector responds to received pause instructions.

6. The communications queue controller as claimed in claim 1, wherein the communications network is an Ethernet network.

7. The communications queue controller as claimed in claim 1, wherein the programmable bit is on for at least one of the plurality of queue buffers that is of a high priority and is off for at least one of the plurality of queue buffers that is of a low priority.

8. The communications queue controller as claimed in claim 7, wherein the at least one queue buffer of a high priority has a transmission rate less than an upstream access line transmission rate.

9. A communications terminal comprising:
a plurality of queue buffers to output queue congestion status data;
an appender to append the queue congestion status data to data frames sent from the first terminal to the second terminal; and
a dummy frame generator to generate dummy frames in the absence of data frames, wherein the appender is coupled to the dummy frame generator to append the queue congestion status data to the dummy data frames in the absence of data frames.

10. The communications terminal as claimed in claim 9, wherein the queue congestion status data is appended to the end of every data frame.

11. The communications terminal as claimed in claim 9, wherein the queue congestion status data is inserted into the data frame or the dummy data frame only when the queue congestion status data changes.

12. The communications terminal as claimed in claim 9, wherein the queue congestion status data comprises a first bit to indicate whether the data frame is a data frame or a dummy frame, and a plurality of bits, each of the plurality of bits comprising an on/off instruction for an individual queue of the plurality of queue buffers.

13. The communications terminal as claimed in claim 7, wherein the communications terminal is an Ethernet network.

14. A method to control data flow from a second terminal to a first terminal of a communications network, the method comprising:
sending queue congestion status data from the first terminal to the second terminal, the queue congestion status data being selected from the group consisting of: a standard pause frame, an insert to a data frame, an attachment to a data frame, an attachment to a dummy data frame, and an insert to a dummy data frame;
extracting the congestion status data at the second terminal; and
using the queue congestion status data to individually control each of a plurality of queue buffers in the second terminal.

15. The method as claimed in claim 14, wherein the congestion status data is appended to every data frame sent from the first terminal to the second terminal.

16. The method as claimed in claim 14, wherein the congestion status data comprises a first bit to indicate whether the data frame is a data frame or a dummy data frame, and a plurality of bits; each of the plurality of bits comprising an on/off instruction for an individual queue of the plurality of queue buffers.

17. The method as claimed in claim 14, wherein the dummy data frame is provided to send the queue congestion status data if no data frames are transmitted from the first terminal to the second terminal.

18. The method as claimed in claim 17, wherein the dummy data frame is extracted with the queue congestion status data.

19. The method as claimed in claim 14, wherein the insert to the data frame and the insert to the dummy data frame both comprise a tag prefix inserted into the data frame and the dummy data frame only when the queue congestion status data changes.

20. The method as claimed in claim 19, wherein the tag prefix comprises a tag protocol type, and tag control information.

21. The method as claimed in claim 20, wherein the tag control information comprises a first bit to indicate whether the data frame is a data frame or a dummy data frame, and a plurality of bits; each of the plurality of bits comprising an on/off instruction for an individual queue of the plurality of queue buffers.

22. The method as claimed in claim 14, wherein the plurality of queue buffers in the second terminal comprises a scheduling block, each scheduling block comprising a programmable bit to control a flow control selector for each of the plurality of queues.

23. The method as claimed in claim 22, wherein when the programmable bit is on, the flow control selector is enabled and does not respond to received queue congestion status data; and when the programmable bit is off, the flow control selector responds to received queue congestion status data.

24. The method as claimed in claim 23, wherein the queue congestion status data is a pause frame.

25. The method as claimed in claim 23, wherein the programmable bit is set to on for at least one of the plurality of queue buffers that is of a high priority and is set to off for at least one of the plurality of queue buffers that is of a low priority.

26. A signal encoding a data frame, the data frame comprising queue congestion status data, the data frame being configured to be sent from a first terminal to a second terminal, the queue congestion status data being configured to control data flow from the second terminal to the first terminal, the queue congestion status data comprising a plurality of queue buffer on/off instructions to individually control each of a plurality of queue buffers in the second terminal.

27. The data frame as claimed in claim 26, wherein the queue congestion status data comprises a first bit to indicate whether the data frame is a data frame or a dummy data frame, and a plurality of bits; each of the plurality of bits comprising one of the plurality of on/off instructions.

28. The data frame as claimed in claim 26 further comprising a tag prefix inserted into the data frame only when the queue congestion status data changes.

29. The data frame as claimed in claim 28, wherein the tag prefix comprises a tag protocol type, and tag control information.

30. An Ethernet network flow control system comprising:
a first terminal to send queue congestion status data from the first terminal to a second terminal to control data flow from the second terminal to the first terminal, the congestion status data being selected from the group consisting of: a standard pause frame, an insert to a data frame, an attachment to a data frame, an attachment to a dummy data frame, and an insert to a dummy data frame;
the second terminal having an extractor to extract the queue congestion status data at the second terminal; and
the second terminal using the queue congestion status data to individually control each of a plurality of queue buffers in the second terminal.

31. The system as claimed in claim 30, wherein the first terminal comprises at least one selected from the group consisting of: a standard pause frame generator, an appender to append the queue congestion status data to data frames sent from the first terminal to the second terminal, and a dummy frame generator to generate dummy frames in the absence of data frames.

32. The system as claimed in claim 31, wherein the queue congestion status data is appended to the dummy data frames in the absence of data frames.

33. The system as claimed in claim 31, wherein the first terminal comprises a plurality of first terminal queue buffers, each of the plurality of first terminal queue buffers being configured to output queue congestion status data.

34. A software component that is operable on at least one processor, the software component comprising a computer program that configures the at least one processor to control data flow from a second terminal to a first terminal of a communications network by:
sending queue congestion status data from the first terminal to the second terminal, the congestion status data being selected from the group consisting of: a standard pause frame, an insert to a data frame, an attachment to a data frame, an attachment to a dummy data frame, and an insert to a dummy data frame;
extracting the congestion status data at the second terminal; and
using the congestion status data to individually control each of a plurality of queue buffers in the second terminal.

35. A communications queue controller for a communications network to control data flow from a second terminal to a first terminal of the communications network, the system comprising:
means for sending queue congestion status data from the first terminal to the second terminal, the queue congestion status data being selected from the group consisting of: a standard pause frame, an insert to a data frame, an attachment to a data frame, an attachment to a dummy data frame, and an insert to a dummy data frame;
means for extracting the congestion status data at the second terminal; and
means for using the queue congestion status data to individually control each of a plurality of queue buffers in the second terminal.

36. The communications queue controller as claimed in claim 35, wherein the congestion status data is appended to every data frame sent from the first terminal to the second terminal.

37. The communications queue controller as claimed in claim 35, wherein the congestion status data comprises a first bit to indicate whether the data frame is a data frame or a dummy data frame, and a plurality of bits; each of the plurality of bits comprising an on/off instruction for an individual queue of the plurality of queue buffers.

38. The communications queue controller as claimed in claim 35, wherein the dummy data frame is provided to send the queue congestion status data if no data frames are transmitted from the first terminal to the second terminal.

39. The communications queue controller as claimed in claim 38, wherein the dummy data frame is extracted with the queue congestion status data.

40. The communications queue controller as claimed in claim 35, wherein the insert to the data frame and the insert to the dummy data frame both comprise a tag prefix inserted into the data frame and the dummy data frame only when the queue congestion status data changes.

41. The communications queue controller as claimed in claim 40, wherein the tag prefix comprises a tag protocol type, and tag control information.

42. The communications queue controller as claimed in claim 41, wherein the tag control information comprises a first bit to indicate whether the data frame is a data frame or a dummy data frame, and a plurality of bits; each of the plurality of bits comprising an on/off instruction for an individual queue of the plurality of queue buffers.

43. The communications queue controller as claimed in claim 35, wherein the plurality of queue buffers in the second terminal comprises a scheduling block, each scheduling block comprising a programmable bit to control a flow control selector for each of the plurality of queues.

44. The communications queue controller as claimed in claim 43, wherein when the programmable bit is on, the flow control selector is enabled and does not respond to received queue congestion status data; and when the programmable bit is off, the flow control selector responds to received queue congestion status data.

45. The communications queue controller as claimed in claim 44, wherein the queue congestion status data is a pause frame.

46. The communications queue controller as claimed in claim 44, wherein the programmable bit is set to on for at least one of the plurality of queue buffers that is of a high priority and is set to off for at least one of the plurality of queue buffers that is of a low priority.
